(19) United States
(12) Patent Application Publication
(10) Pub. No.: US 2025/0224756 A1
(43) Pub. Date: Jul. 10, 2025

(54) FORCE FEEDBACK FOR WELL OPERATIONS CONTROLLER

(71) Applicant: WEATHERFORD TECHNOLOGY HOLDINGS, LLC, HOUSTON, TX (US)

(72) Inventor: Leonardo J. GUTIERREZ, Cypress, TX (US)

(21) Appl. No.: 18/637,176

(22) Filed: Apr. 16, 2024

Related U.S. Application Data
(60) Provisional application No. 63/619,017, filed on Jan. 9, 2024.

(51) Int. Cl. G05G 9/047; E21B 3/02; E21B 19/00; E21B 19/06; E21B 19/16

(52) U.S. Cl. CPC G05G 9/047; E21B 3/022; E21B 19/008; E21B 19/06; E21B 19/161; G05G 2009/04766; G05G 2505/00

(57) ABSTRACT

A method for use with a subterranean well can include operating a human interface controller to control a well operation, thereby producing an operational force in the well operation, and applying a feedback force to an input structure of the human interface controller, the feedback force being based on the operational force. A system for use with a subterranean well can include a human interface controller configured to receive human input to control a well operation, and a control system configured to produce an operational force in the well operation in response to the human input. The control system is further configured to produce a feedback force in the human interface controller in opposition to the human input.

### CROSS-REFERENCE TO RELATED APPLICATION

This application claims the benefit of the filing date of U.S. provisional application No. 63/619,017 filed on 9 Jan. 2024. The entire disclosure of the prior application is incorporated herein by this reference in its entirety for all purposes.

### BACKGROUND

This disclosure relates generally to equipment utilized and operations performed in conjunction with a subterranean well and, in an example described below, more particularly provides for force feedback in a controller used in well operations.

Although well operations are increasingly becoming automated, many operations are still controlled by direct human input. The human input may be delivered via devices, such as, a joystick, a lever, a “mouse,” etc.

It will, therefore, be readily appreciated that improvements are continually needed in the art of controlling well operations. Such improvements may be used with a wide variety of different well operations, including but not limited to, drilling, tubular connection make up and break out, logging, tubular string installation and retrieval, etc.

### BRIEF DESCRIPTION OF THE DRAWINGS

FIG. 1 is a representative elevational view of an example of a well system and associated method which can embody principles of this disclosure.

FIG. 2 is a representative elevational view of another example of a well system and associated method which can embody the principles of this disclosure.

FIG. 3 is a representative elevational view of another example of a well system and associated method which can embody the principles of this disclosure.

FIG. 4 is a representative elevational view of another example of a well system and associated method which can embody the principles of this disclosure.

FIG. 5 is a representative partially cross-sectional view of examples of a human interface controller and a control system that may be used in the FIGS. 1-4 systems and methods.

### DETAILED DESCRIPTION

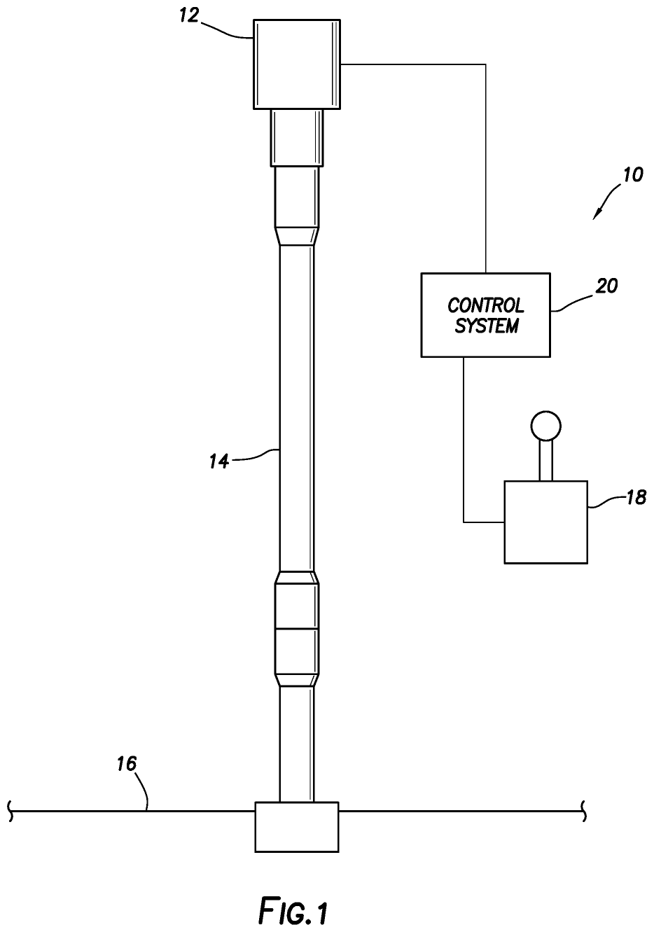

Representatively illustrated in FIG. 1 is a system 10 for use with a subterranean well, and an associated method, which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 system 10, a well drilling operation is being performed. In this example, a top drive 12 is connected to an upper end of a tubular string 14 (known as a drill string to those skilled in the art). The tubular string 14 extends downward through a rig floor 16 and into a wellbore (not shown) drilled into the earth. A drill bit (not shown) connected at a distal end of the tubular string 14 is rotated to thereby cut into the earth and further drill the wellbore.

The top drive 12 is used to rotate the tubular string 14. The top drive 12 applies rotation and torque (a twisting or turning force applied at a distance from a center of rotation) to the tubular string 14.

In addition, the top drive 12 typically applies an upwardly directed lifting force to the tubular string 14 as it is being rotated, so that a portion of the drill string's weight is applied to the drill bit in the wellbore (known to those skilled in the art as “weight on bit”). Since less than all of the drill string's weight is typically applied at the drill bit, the top drive 12 applies a tensile force to an upper portion of the tubular string 14.

The application of the torque and tensile force to the tubular string 14 by the top drive 12 is controlled by a human operator via a human interface controller 18. In the FIG. 1 example, the human interface controller 18 is depicted as a device known as a “joystick.” Other types of controller devices may be used in other examples.

Signals output by the controller 18 are communicated to a control system 20 for the top drive 12. The control system 20 controls operation of the top drive 12 in response to the output of the controller 18, which is controlled by human input (in this case, physical manipulation of the joystick by the human operator).

The control system 20 may include computing devices (such as, one or more processors), memory (such as, for storage of instructions, software, algorithms, etc.) and specialized devices (such as a programmable logic controller). At least one function performed by the control system 20 is to cause the top drive 12 to be operated in accordance with the signals output from the controller 18, so that the human operator's inputs to the controller 18 are effectively translated into operational forces (e.g., torque, tensile force, etc.) delivered by the top drive to the tubular string 14. Other parameters (such as rotational speed, etc.) of the drilling operation may also be controlled via the controller 18 and control system 20.

In the FIG. 1 system 10, the control system 20 performs an additional function of delivering a signal to the controller 18, so that the controller delivers a feedback force to the human operator in response to the signal. The feedback force gives the human operator a physical indication of the operational force being applied by the top drive 12 to the tubular string 14. This physical indication can immediately alert the operator to changes in the operational forces being applied, which may or may not match the operator's expectations. If corrective action needs to be taken, such corrective action can be more quickly taken, due to the immediate feedback provided to the operator.

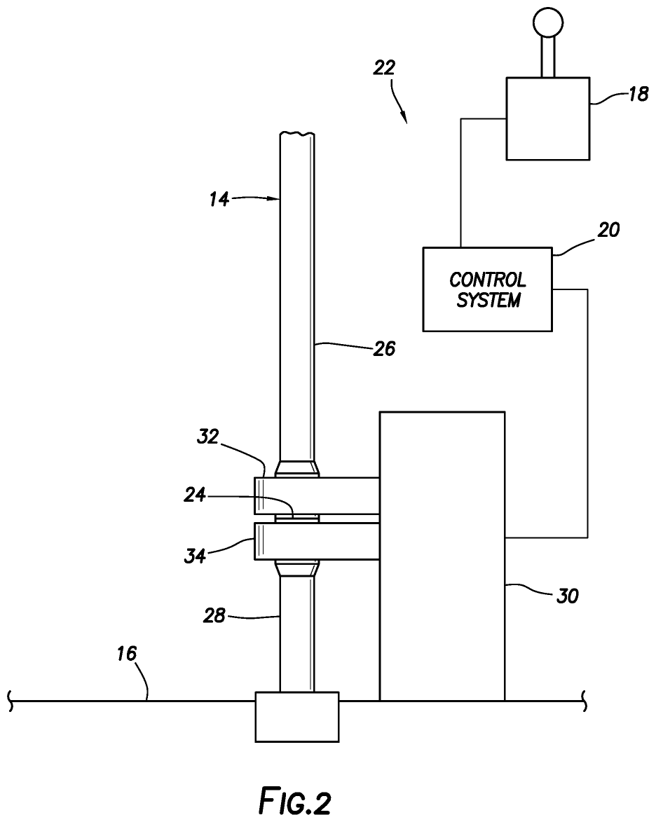

Referring additionally now to FIG. 2, another example of a system 22 and method for use with a subterranean well is representatively illustrated. Elements of the system 22 which are similar to those described above are indicated in FIG. 2 using the same reference numbers.

In the FIG. 2 system 22, a tubular connection 24 is being made up or broken out. The tubular connection 24 is between an upper tubular 26 and a lower tubular 28 extending downward through the rig floor 16. The tubulars 26, 28 may be any type of tubulars used in well operations, such as, drill pipe, production tubing, casing, liner, tubular well tools, etc.

A tong assembly 30 is used to apply torque to the tubular connection 24 to make up or break out the tubular connection. The tong assembly 30 in this example includes an upper rotary tong 32 and a lower backup tong 34. The rotary tong 32 grips the upper tubular 26 and applies torque and rotation to the upper tubular. The backup tong 34 reacts the torque applied by the rotary tong 32 and thereby prevents rotation of the lower tubular 28.

The control system 20 in this example controls operation of the tong assembly 30, based on the signals output by the human interface controller 18 in response to operator input. In particular, the control system 20 causes the tong assembly 30 to be operated in accordance with the signals output from the controller 18, so that the human operator's inputs to the controller 18 are effectively translated into operational forces (e.g., torque) delivered by the tong assembly to the tubular connection 24. Other parameters (such as rotational speed, etc.) of the make up or break out operation may also be controlled via the controller 18 and control system 20.

In the FIG. 2 system 22, the control system 20 performs an additional function of delivering a signal to the controller 18, so that the controller delivers a feedback force to the human operator in response to the signal. The feedback force gives the human operator a physical indication of the operational force being applied by the tong assembly 30 to the tubular connection 24. This physical indication can immediately alert the operator to changes in the operational forces being applied, which may or may not match the operator's expectations. If corrective action needs to be taken, such corrective action can be more quickly taken, due to the immediate feedback provided to the operator.

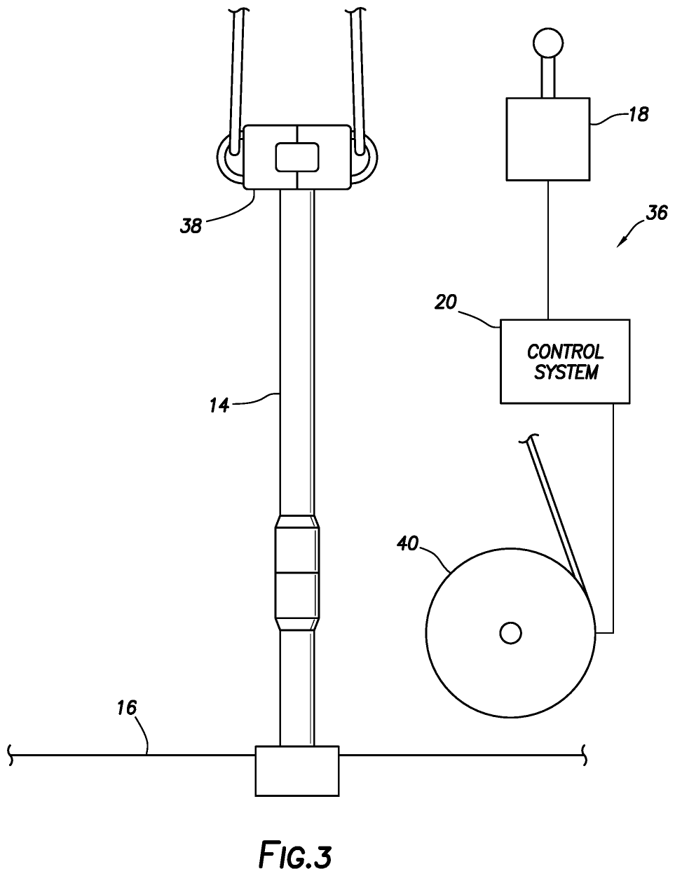

Referring additionally now to FIG. 3, another example of a system 36 and method for use with a subterranean well is representatively illustrated. Elements of the system 22 which are similar to those described above are indicated in FIG. 3 using the same reference numbers.

In the FIG. 3 example, the tubular string 14 is being installed in, or retrieved from, the wellbore (not shown) below the rig floor 16. To suspend the tubular string 14, an elevator 38 is connected at an upper end of the tubular string. The elevator 38 is raised and lowered by means of a draw works 40.

The draw works 40 applies a lifting force to the elevator 38. The lifting force applied to the elevator 38 results in a tensile force being applied to an upper portion of the tubular string 14.

The control system 20 in this example controls operation of the draw works 40, based on the signals output by the human interface controller 18 in response to operator input. In particular, the control system 20 causes the draw works 40 to be operated in accordance with the signals output from the controller 18, so that the human operator's inputs to the controller 18 are effectively translated into operational forces (e.g., tensile force) delivered by the draw works to the tubular string 14. Other parameters (such as brake force, etc.) of the tubular string installation or retrieval operation may also be controlled via the controller 18 and control system 20.

In the FIG. 3 system 36, the control system 20 performs an additional function of delivering a signal to the controller 18, so that the controller delivers a feedback force to the human operator in response to the signal. The feedback force gives the human operator a physical indication of the operational force being applied by the draw works 40 to the tubular string 14. This physical indication can immediately alert the operator to changes in the operational forces being applied, which may or may not match the operator's expectations. If corrective action needs to be taken, such corrective action can be more quickly taken, due to the immediate feedback provided to the operator.

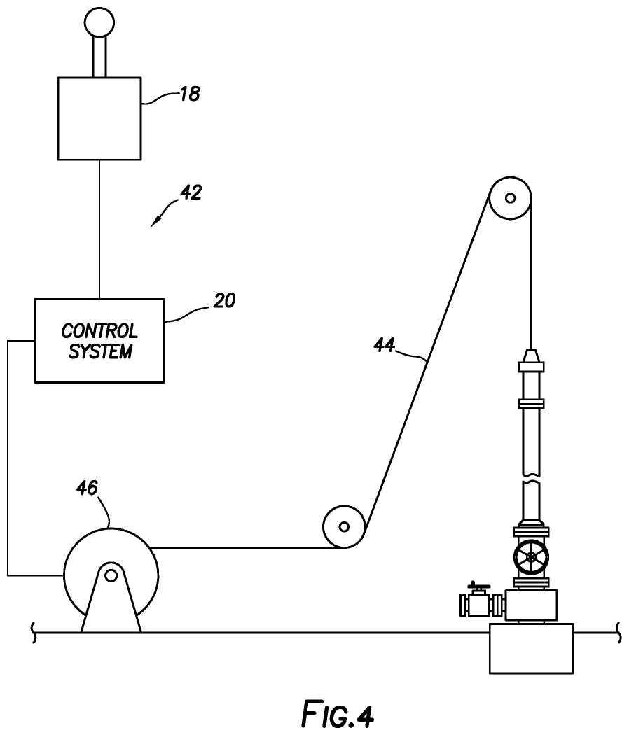

Referring additionally now to FIG. 4, another example of a system 42 and method for use with a subterranean well is representatively illustrated. Elements of the system 42 which are similar to those described above are indicated in FIG. 4 using the same reference numbers.

In the FIG. 4 system 42, a wireline operation is being performed. The wireline operation may be any type of operation performed with a wireline 44 (including but not limited to armored cable, slickline, electric line, or coiled tubing) used to convey one or more well tools (such as, logging tools, perforators, reservoir testers or samplers, plugs, packers, etc.) into and out of a wellbore.

The wireline 44 is wrapped about a reel or spool 46, which is rotated (e.g., using an electric or hydraulic motor, a gear reducer, etc.) to thereby raise or lower the wireline and well tools in the wellbore. A tensile force is applied to the wireline 44 by operation of the spool 46.

The control system 20 in this example controls operation of the spool 46, based on the signals output by the human interface controller 18 in response to operator input. In particular, the control system 20 causes the spool 46 to be operated in accordance with the signals output from the controller 18, so that the human operator's inputs to the controller 18 are effectively translated into operational forces (e.g., tensile force) delivered by the spool to the wireline 44. Other parameters (such as speed, etc.) of the spool 46 rotation may also be controlled via the controller 18 and control system 20.

In the FIG. 4 system 42, the control system 20 performs an additional function of delivering a signal to the controller 18, so that the controller delivers a feedback force to the human operator in response to the signal. The feedback force gives the human operator a physical indication of the operational force being applied by the spool 46 to the wireline 44. This physical indication can immediately alert the operator to changes in the operational forces being applied, which may or may not match the operator's expectations. If corrective action needs to be taken, such corrective action can be more quickly taken, due to the immediate feedback provided to the operator.

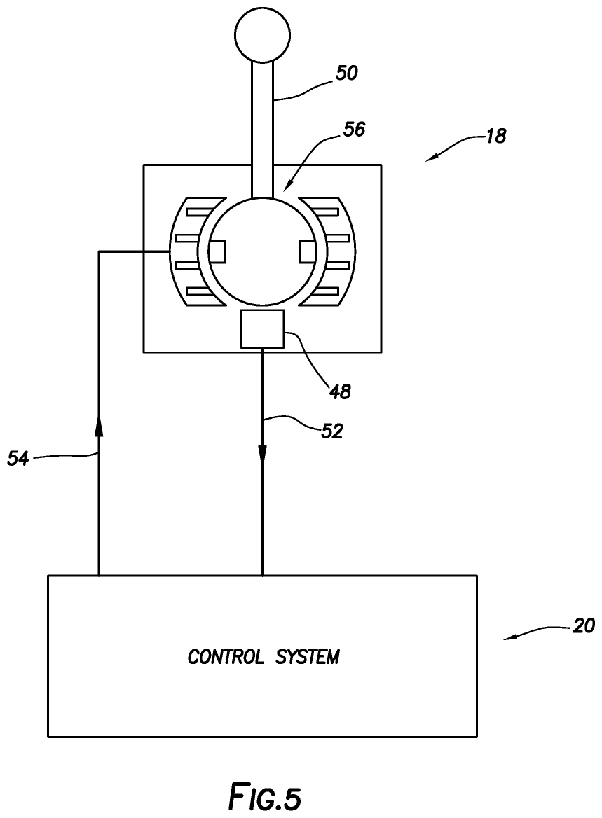

Referring additionally now to FIG. 5, a partially cross-sectional view of examples of a human interface controller 18 and a control system 20 that may be used in the FIGS. 1-4 systems 10, 22, 36, 42 and methods are representatively illustrated. However, it should be clearly understood that the controller 18 and control system 20 may be used with other systems and methods in keeping with the scope of this disclosure.

In the FIG. 5 example, the controller 18 includes one or more sensors 48 for sensing a position of a joystick 50. The sensor 48 produces output signals 52 that are communicated to the control system 20. In response, the control system 20 causes equipment (e.g., the top drive 12, the tong assembly 30, the draw works 40, the spool 46, etc.) to be operated in a particular manner, for example, according to the instructions, software and/or algorithms supplied with the control system.

In addition, the control system 20 provides input signals 54 to the controller 18 for providing feedback forces to the operator. The signals 54 are based on the operational forces applied in the well system due to the operator input to the controller 18. The signals 54 result in the feedback forces being applied in opposition to the operator's input.

For example, if an operator rotates the joystick 50 in a particular direction to thereby direct the control system 20 to cause the equipment to apply a certain operational force in a well system, the feedback force will bias the joystick to rotate in an opposite direction. The amount of feedback force applied to the joystick 50 is based on an algorithm described more fully below.

Note that the joystick 50 is just one example of a type of input structure that may be physically manipulated by an operator to cause a corresponding signal 52 to be communicated to the control system 20. Other types of input structures could include levers, pedals, dials, plungers, triggers, etc. The scope of this disclosure is not limited to use of any particular type of input structure.

The amount of operational force applied may be measured or detected using any appropriate means. For example, in the FIG. 1 system 10, the amount of torque applied by the top drive 12 to the tubular string 14 may be measured using a torque sensor, and a load cell may be used to measure the amount of tension applied to the upper portion of the tubular string. In the FIG. 2 system 22, the amount of torque applied to the tubular connection 24 by the tong assembly 30 may be measured by a torque sensor. In the FIG. 3 system 36, the lifting force applied to the elevator 38 by the draw works 40 may be measured by a load cell. In the FIG. 4 system 42, the tensile force applied to the wireline 44 by the spool 46 may be measured by a load cell. The scope of this disclosure is not limited to any particular sensor or other means of measuring the operational force applied in a well system.

The signals 54 communicated from the control system 20 to the controller 18 are used to generate the feedback forces applied to the joystick 50. In the FIG. 5 example, the controller 18 includes a spherical actuator 56 connected to the joystick 50. The spherical actuator 56 will produce the feedback forces applied to the joystick 50 in opposition to the physical input to the joystick by the human operator.

As mentioned above, the feedback force is based on the operational force applied in the well system being controlled by use of the controller 18. In one example, the feedback force is proportional to a derivative of the operational force over time. This relationship between the operational force and the feedback force can be expressed as the algorithm: FBF=G (dF/dt), in which FBF is the feedback force, G is gain, F is the operational force, t is time, and (dF/dt) is a derivative of the operational force over time. In this manner, the feedback force increases as a rate of change of the operational force increases, and vice versa.

The algorithm may be implemented in the control system 20 (for example, as part of the software or instructions stored therein) or in the controller 18, or another component of the well system. The scope of this disclosure is not limited to any particular component in which the algorithm is applied to the measurement of the operational force or its rate of change over time.

It may now be fully appreciated that the above disclosure provides significant advancements to the art of controlling well operations by operator input. In examples described above, a feedback force FBF is generated in the human interface controller 18, so that the operator is immediately aware of changes in the operational force F applied in a well operation.

The above disclosure provides to the art a method for use with a subterranean well. In one example, the method can comprise: operating a human interface controller 18 to control a well operation, thereby producing an operational force F in the well operation; and applying a feedback force FBF to an input structure (such as the joystick 50) of the human interface controller 18, the feedback force FBF being based on the operational force F.

The feedback force FBF may be proportional to a derivative of the operational force F over time t. The feedback force FBF may be generated according to the following algorithm: FBF=G (dF/dt), wherein FBF is the feedback force, G is gain, F is the operational force, t is time, and (dF/dt) is a derivative of the operational force over time.

The operational force F may comprise a torque applied to a tubular connection 24, a torque applied to a tubular string 14, a tensile force applied to a tubular string 14, or a tensile force applied to a wireline 44.

The above disclosure also provides a system 10, 22, 36, 42 for use with a subterranean well. In one example, the system 10, 22, 36, 42 can comprise a human interface controller 18 configured to receive human input to control a well operation, and a control system 20 configured to produce an operational force F in the well operation in response to the human input. The control system 20 is further configured to produce a feedback force FBF in the human interface controller 18 in opposition to the human input.

The control system 20 may be configured to produce the feedback force FBF based on the operational force F. The control system 20 may be configured to produce the feedback force FBF proportional to a derivative of the operational force F over time t. The control system 20 may be configured to produce the feedback force FBF according to the following algorithm: FBF=G (dF/dt), wherein FBF is the feedback force, G is gain, F is the operational force, t is time, and (dF/dt) is a derivative of the operational force over time.

Another method described above for use with a subterranean well can comprise: operating a human interface controller 18 to control a well operation, thereby producing an operational force F in the well operation; and applying a feedback force FBF to an input structure (such as the joystick 50) of the human interface controller 18. The feedback force FBF is proportional to a derivative of the operational force F over time t.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method for use with a subterranean well, the method comprising:
operating a human interface controller to control a well operation, thereby producing an operational force in the well operation; and
applying a feedback force to an input structure of the human interface controller, the feedback force being based on the operational force.

2. The method of claim 1, in which the feedback force is proportional to a derivative of the operational force over time.

3. The method of claim 1, in which the feedback force is generated according to the following algorithm: FBF=G (dF/dt), wherein FBF is the feedback force, G is gain, F is the operational force, t is time, and (dF/dt) is a derivative of the operational force over time.

4. The method of claim 1, in which the operational force comprises a torque applied to a tubular connection.

5. The method of claim 1, in which the operational force comprises a torque applied to a tubular string.

6. The method of claim 1, in which the operational force comprises a tensile force applied to a tubular string.

7. The method of claim 1, in which the operational force comprises a tensile force applied to a wireline.

8. A system for use with a subterranean well, the system comprising:
a human interface controller configured to receive human input to control a well operation; and
a control system configured to produce an operational force in the well operation in response to the human input,
in which the control system is further configured to produce a feedback force in the human interface controller in opposition to the human input.

9. The system of claim 8, in which the control system is configured to produce the feedback force based on the operational force.

10. The system of claim 8, in which the control system is configured to produce the feedback force proportional to a derivative of the operational force over time.

11. The system of claim 8, in which the control system is configured to produce the feedback force according to the following algorithm: FBF=G (dF/dt), wherein FBF is the feedback force, G is gain, F is the operational force, t is time, and (dF/dt) is a derivative of the operational force over time.

12. The system of claim 8, in which the operational force comprises a torque applied to a tubular connection.

13. The system of claim 8, in which the operational force comprises a torque applied to a tubular string.

14. The system of claim 8, in which the operational force comprises a tensile force applied to a tubular string.

15. The system of claim 8, in which the operational force comprises a tensile force applied to a wireline.

16. A method for use with a subterranean well, the method comprising:
operating a human interface controller to control a well operation, thereby producing an operational force in the well operation; and
applying a feedback force to an input structure of the human interface controller, the feedback force being proportional to a derivative of the operational force over time.

17. The method of claim 16, in which the operational force comprises a torque applied to a tubular connection.

18. The method of claim 16, in which the operational force comprises a torque applied to a tubular string.

19. The method of claim 16, in which the operational force comprises a tensile force applied to a tubular string.

20. The method of claim 16, in which the operational force comprises a tensile force applied to a wireline.
